(19) United States
(12) Patent Application Publication
(10) Pub. No.: US 2015/0050523 A1
(43) Pub. Date: Feb. 19, 2015

(54) BATTERY PACK

(71) Applicant: Samsung SDI Co., Ltd., Yongin-si (KR)

(72) Inventor: Hyeok Lee, Yongin-si (KR)

(73) Assignee: Samsung SDI Co., Ltd., Yongin-si (KR)

(21) Appl. No.: 14/087,987

(22) Filed: Nov. 22, 2013

(30) Foreign Application Priority Data
Aug. 14, 2013 (KR) 10-2013-0096900

(51) Int. Cl. H01M 2/06; H01M 2/34

(52) U.S. Cl. CPC H01M 2/06; H01M 2/34
USPC 429/7; 429/179

(57) ABSTRACT

A battery pack includes: a battery cell including one or more coupling holes formed in a terrace part; and a case accommodating the battery cell and including a fixing protrusion configured to be coupled to the coupling hole. The battery cell further includes: an electrode assembly in which a positive electrode plate, a separator, and a negative electrode plate are sequentially stacked; a pouch in which the electrode assembly is sealed; and a lead tab connected to the electrode assembly and partially exposed to an outside of the pouch.

### CROSS-REFERENCE TO RELATED APPLICATIONS

This application claims the benefit of Korean Patent Application No. 10-2013-0096900, filed on Aug. 14, 2013, in the Korean Intellectual Property Office, the disclosure of which is incorporated herein in its entirety by reference.

### BACKGROUND OF THE INVENTION

1. Field of the Invention

One embodiment of the present invention relates to a battery pack.

2. Description of the Related Art

Secondary batteries are used in various industrial fields due to their many advantages. For example, secondary batteries are widely used as energy sources for mobile electronic devices such as digital cameras, cellular phones, and laptop computers. In addition, second batteries are used as energy sources for hybrid electric vehicles to solve air pollution problems caused by internal combustion engine vehicles using fossil fuels such as gasoline and diesel oil. Such secondary batteries may be stably packed in cases.

### SUMMARY OF THE INVENTION

One embodiment of the present invention includes a battery pack in which a battery cell is stably disposed in a case.

Additional aspects will be set forth in part in the description which follows and, in part, will be apparent from the description, or may be learned by practice of the presented embodiments.

According to one embodiment of the present invention, a battery pack includes: a battery cell including a terrace part and one or more coupling holes formed in the terrace part; and a case accommodating the battery cell and including a fixing protrusion configured to be coupled to the coupling hole, wherein the battery cell includes: an electrode assembly in which a positive electrode plate, a separator, and a negative electrode plate are sequentially stacked; a pouch in which the electrode assembly is sealed; and a lead tab connected to the electrode assembly and partially exposed to an outside of the pouch.

The coupling hole may be formed in the terrace part through the pouch.

The coupling hole may be spaced apart from the lead tab.

The lead tab may include first and second lead tabs having different polarities, and the coupling holes may be formed in the terrace part with the first and second lead tabs being disposed therebetween.

The terrace part may include an insulation member surrounding the lead tab.

The case may include: a first support portion accommodating and supporting the battery cell, the first support portion including the fixing protrusion; and a second support portion accommodating and supporting a protective circuit module.

The fixing protrusion may protrude from the first support portion and correspond to the coupling hole.

The case may include a plurality of first support portions at left and right sides of the second support portion to accommodate a plurality of battery cells.

The lead tab of the battery cell may face the second support portion, and the battery cell may be connected to the protective circuit module.

The first support portion may be in a thermal contact with the pouch for dissipating heat.

The coupling hole may be coupled with the fixing protrusion for insulating the battery cell.

According to one embodiment of the present invention, a battery pack includes: a battery cell including at least one coupling hole formed in a terrace part; and a case accommodating the battery cell and a protective circuit module, the protective circuit module including a fixing protrusion configured to be coupled to the coupling hole, wherein the battery cell includes: an electrode assembly in which a positive electrode plate, a separator, and a negative electrode plate are sequentially stacked; a pouch in which the electrode assembly is sealed; and a lead tab connected to the electrode assembly and partially exposed to an outside of the pouch.

The case may include: a first support portion accommodating the battery cell; and a second support portion accommodating the protective circuit module.

The case may include a plurality of first support portions at left and right sides of the second support portion to accommodate a plurality of battery cells.

The coupling hole may be formed in the terrace part through the pouch.

The coupling hole may be spaced apart from the lead tab.

The battery cell may further include an insulation member disposed at the terrace part to surround the lead tab.

The fixing protrusion may correspond to the coupling hole.

A battery pack may include a battery cell comprising a terrace part; a case accommodating the battery cell wherein a coupling hole is formed on one of the terrace part or the case and a fixing protrusion is formed on either the terrace part or the case that does not have the protrusion so that the fixing protrusion engages with the coupling hole to secure the case to the terrace part.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic perspective view illustrating a battery pack according to an embodiment of the present invention;

FIG. 2 is an exploded perspective view of the battery pack illustrated in FIG. 1;

FIG. 3 is an enlarged perspective view of Portion A of FIG. 1;

FIG. 4 is a schematic perspective view illustrating a battery cell according to an embodiment of the present invention;

FIG. 5 is a schematic cross-sectional view illustrating the battery cell according to an embodiment of the present invention; and

FIG. 6 is an exploded perspective view schematically illustrating a battery pack according to another embodiment of the present invention.

### DETAILED DESCRIPTION OF THE PREFERRED EMBODIMENT

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. In the following description, the technical terms are used only for explaining exemplary embodiments, and not for purposes of limitation. The terms of a singular form may include plural forms unless specifically mentioned. The meaning of ‘comprises’ and/or ‘comprising’ specifies an element, a step, a process, an operation, and/or a device but does not exclude other elements, steps, processes, operations, and/or devices. It will be understood that although the terms of first and second are used herein to describe various elements, these elements should not be limited by these terms. Terms are only used to distinguish one element from other elements.

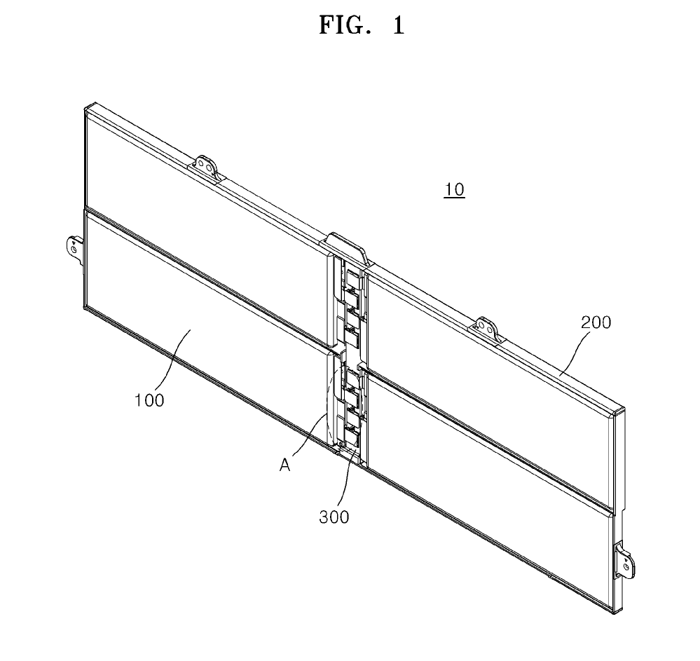

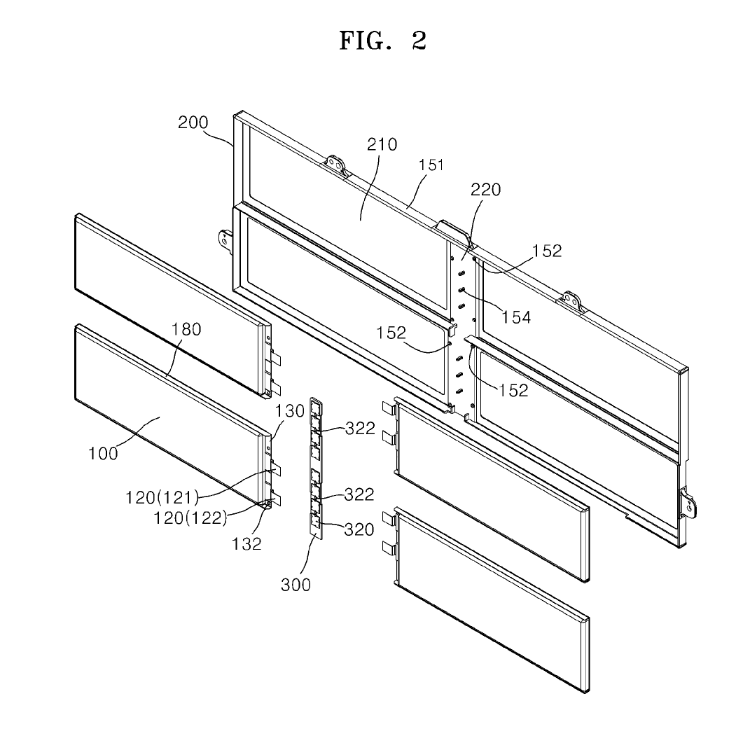

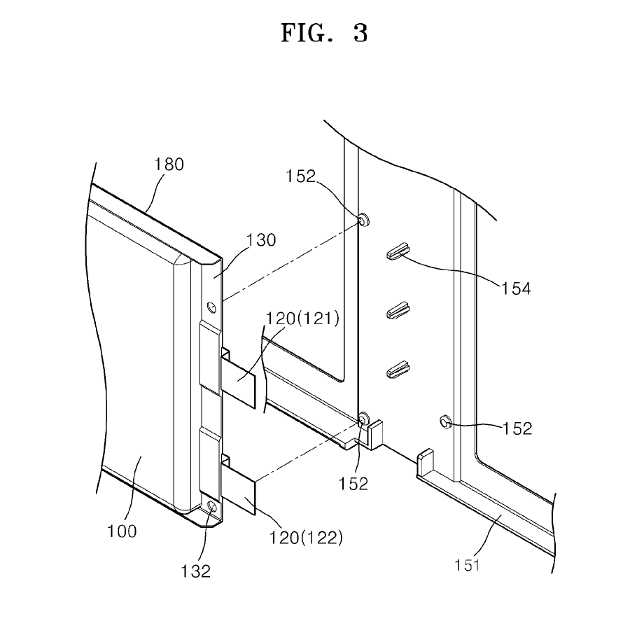

FIG. 1 is a schematic perspective view illustrating a battery pack 10 according to an embodiment of the present invention, and FIG. 2 is an exploded perspective view of the battery pack 10 illustrated in FIG. 1. FIG. 3 is an enlarged perspective view of Portion A of FIG. 1.

Referring to FIGS. 1 to 3, the battery pack 10 of the current embodiment includes a plurality of battery cells 100, a case 200 accommodating the battery cells 100, and a protective circuit module 300 controlling charging and discharging of the battery cells 100.

For example, the battery cells 100 may be rechargeable lithium-ion secondary battery cells. Each of the battery cells 100 includes lead tabs 120 extending from sides thereof, and coupling holes 132 formed in terrace parts 130.

The case 200 accommodates at least one battery cell 100 and the protective circuit module 300. In FIG. 1, the case 200 accommodates four battery cells 100. However, the embodiments of the present invention are not limited thereto. The case 200 may accommodate at least one battery cell 100.

In FIGS. 1 and 2, the battery cells 100 have the same size and shape. However, the embodiments of the present invention are not limited thereto. That is, the battery cells 100 may have different sizes (capacities) and shapes.

In FIGS. 1 and 2, the battery cells 100 are arranged at the left and right sides of the protective circuit module 300 in the battery pack 10. However, the embodiments of the present invention are not limited thereto.

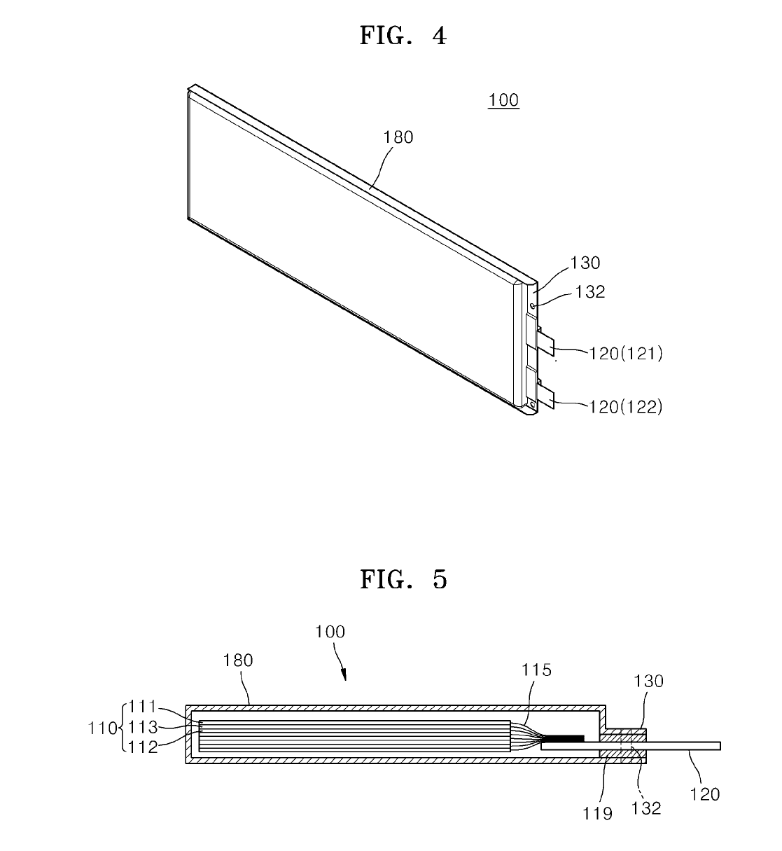

FIG. 4 is a schematic perspective view illustrating one of the battery cells 100 according to an embodiment of the present invention, and FIG. 5 is a schematic cross-sectional view illustrating the battery cell 100 according to an embodiment of the present invention.

Referring to FIGS. 4 to 5, the battery cell 100 may include an electrode assembly 110 formed by stacking a positive electrode plate 111, a separator 113, and a negative electrode plate 112. To increase the output power and capacity of the battery pack 10, a plurality of positive electrode plates 111, a plurality of separators 113, and a plurality of negative electrode plates 112 may be stacked in the electrode assembly 110. The electrode assembly 110 is sealed in a pouch 180.

Although not shown specifically, the positive electrode plates 111 may be formed by coating positive electrode collectors with a positive electrode active material, and the negative electrode plates 112 may be formed by coating negative electrode collectors with a negative electrode active material.

Electrode tabs 115 may be connected to the positive electrode plates 111 and the negative electrode plates 112, respectively. The electrode tabs 115 extending from the positive and negative electrode plates 111 and 112 may be superposed on each other and electrically connected to the lead tabs 120. For example, the electrode tabs 115 and the lead tabs 120 may be connected by ultrasonic welding. However, the embodiments of the present invention are not limited thereto.

The lead tabs 120 extend outward from the battery cell 100 to function as interconnection parts between the battery cell 100 and an external device for allowing a current to flow therebetween. For example, portions of the lead tabs 120 are exposed to the outside of the pouch 180.

The lead tabs 120 may include a first lead tab 121 and a second lead tab 122 having different polarities. The first lead tab 121 may be electrically connected to the positive electrode plates 111 of the electrode assembly 110, and the second lead tab 122 may be electrically connected to the negative electrode plates 112 of the electrode assembly 110. The lead tabs 120 may be spaced apart from the coupling holes 132.

The lead tabs 120 may be formed of a highly conductive metal. For example, the lead tabs 120 may be formed of a metal such as nickel or copper. The first and second lead tab 121 and 122 may be formed of different materials. For example, the first lead tab 121 may include nickel, and the second lead tab 122 may include copper.

Insulation members 119 may be disposed between the pouch 180 and the lead tabs 120 to surround portions of the lead tabs 120 disposed in the terrace part 130 of the battery cell 100 and thus to improve the insulation characteristics of the battery cell 100.

The coupling holes 132 are formed in the terrace part 130 for coupling the battery cell 100 to the case 200.

The coupling holes 132 may be formed through the terrace part 130 of the pouch 180. At least one coupling hole 132 may be formed in the terrace part 130. The coupling holes 132 may be formed in the terrace part 130 at positions spaced apart from edges of the terrace part 130 by a predetermined distance. For example, a pair of coupling holes 132 may be disposed at both sides of the lead tabs 120 and spaced apart from both lateral edges of the terrace part 130. However, embodiments of the present invention are not limited thereto. For example, the coupling holes 132 may be formed at any positions of the terrace part 130 that do not overlap the lead tabs 120.

In FIG. 4, the coupling holes 132 have a circular shape. However, the embodiments of the present invention are not limited thereto. That is, the coupling holes 132 may have any other shapes such as a polygonal shape or an elliptical shape.

Referring to FIGS. 1 to 3, the battery cells 100 may be electrically connected to the protective circuit module 300 through the lead tabs 120. A current may be applied from the battery cells 100 to an external load through the lead tabs 120, or a current may be applied to the battery cells 100 from an external power supply through the lead tabs 120.

The battery cells 100 are coupled to the case 200 and supported by the case 200. Adhesive members (not shown) such as sheets formed of an insulation tape may be disposed between the battery cells 100 and the case 200 to fix the battery cells 100.

The case 200 includes first support portions 210 to accommodate and support the battery cells 100, and a second support portion 220 to accommodate and support the protective circuit module 300 to which the lead tabs 120 extending from the battery cells 100 are connected.

In the case 200, the first support portions 210 are arranged at the left and right sides of the second support portion 220 to accommodate the battery cells 100.

The case 200 may protect the battery cells 100 from impacts and dissipate heat generated from the battery cells 100 during charging and discharging of the battery cells 100.

The first support portions 210 may contain a metal having mechanical rigidity and a high degree of thermal conductivity. For example, the first support portions 210 may contain aluminum. In detail, the first support portions 210 may contain aluminum, and the first support portions 210 may be coated with insulation films formed through an oxidizing process such as anodizing. In this case, although the first support portions 210 are in contact with the battery cells 100 to dissipate heat generated from the battery cells 100, the battery cells 100 may be electrically insulated from the first support portions 210.

The first support portions 210 may have a plate shape. The first support portions 210 may include a plurality of ribs 151 having bent shapes to accommodate and fix the battery cells 100, and fixing protrusions 152 configured to be coupled to the coupling holes 132 of the battery cells 100. The fixing protrusions 152 may be formed to correspond to the coupling holes 132 of the battery cells 100.

For example, the battery cells 100 and the first support portions 210 may be assembled by inserting the fixing protrusions 152 of the first support portions 210 into the coupling holes 132 of the terrace parts 130 of the battery cells 100. The number of the fixing protrusions 152 may correspond to the number of the coupling holes 132, and the shape of the fixing protrusions 152 may be varied according to the shape of the coupling holes 132.

The second support portion 220 includes accommodation protrusions 154 to accommodate the protective circuit module 300. The protective circuit module 300 may be coupled to the accommodation protrusions 154. The protective circuit module 300 may include various protective circuits and a positive temperature coefficient thermistor that are formed on a printed circuit board (PCB).

The protective circuit module 300 may include a plurality of bonding pads 320 and holes 322 for coupling with the accommodation protrusions 154. The bonding pads 320 may be formed of a conductive metal such as nickel. The lead tabs 120 of the battery cells 100 may be coupled to the bonding pads 320 by welding.

The protective circuit module 300 may be electrically connected to the lead tabs 120, and a current may flow to the battery pack 10 and an external device through the protective circuit module 300.

The second support portion 220 may include an insulation material so as to insulate the protective circuit module 300 and prevent the protective circuit module 300 from becoming short-circuited. For example, the second support portion 220 may include a polymer resin such as polyphenylene sulfide (PPS).

According to the embodiment of the present invention, the battery cells 100 each including at least one coupling hole 132 are coupled to the fixing protrusions 152 of the case 200. Therefore, the battery cells 100 may be fixed to the case 200 more firmly. As a result, the battery cells 100 may not move in the case 200 as much, and errors caused by separation of the battery cells 100 from the protective circuit module 300 may be prevented. In addition, noise may not be generated as much because the battery cells 100 do not move in the case 200, and insulation defects of the battery cells 100 may be prevented because the fixing protrusions 152 are firmly inserted in the coupling holes 132.

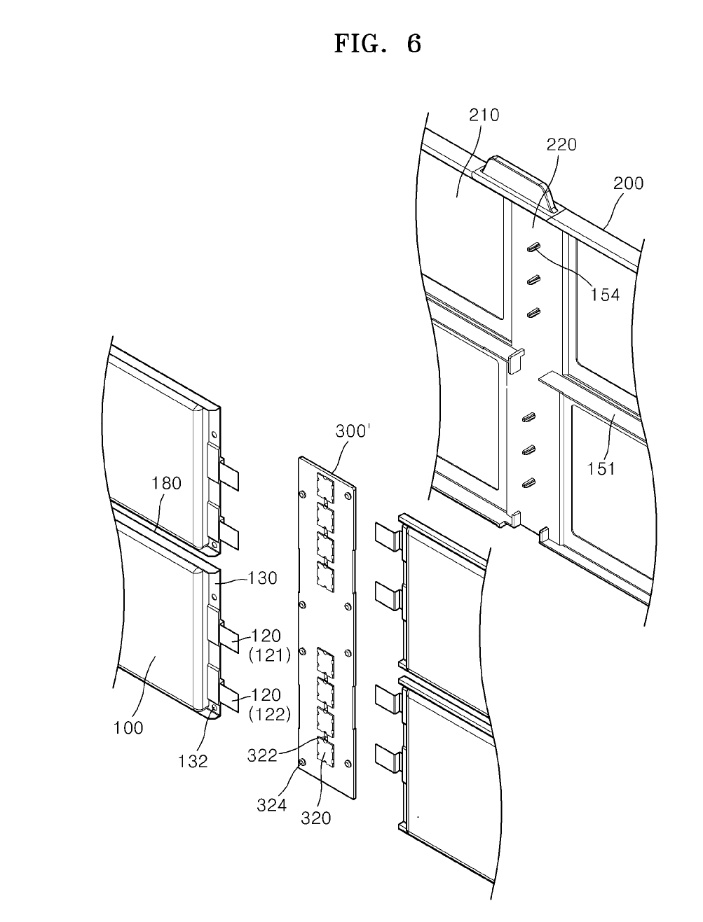

FIG. 6 is an exploded perspective view schematically illustrating a battery pack 10 according to another embodiment of the present invention. In FIG. 6, the same reference numerals as those used in FIG. 2 refer to the same or similar elements, and thus, descriptions thereof will not be repeated.

Referring to FIG. 6, a protective circuit module 300′ includes a plurality of bonding pads 320, holes 322 to be coupled with accommodation protrusions 154, and a plurality of fixing protrusions 324.

Unlike the fixing protrusions 152 illustrated in FIG. 2, the fixing protrusions 324 are formed on the protective circuit module 300′ to be coupled with coupling holes 132 of battery cells 100.

In detail, the protective circuit module 300′ is accommodated in a case 200 using the accommodation protrusions 154 formed on a second support portion 220 of the case 200. The battery cells 100 are accommodated in first support portions 210 of the case 200, and the coupling holes 132 of the battery cells 100 are coupled with the fixing protrusions 324 of the protective circuit module 300′. Therefore, the battery cells 100 may be accommodated in the battery pack 10 more firmly.

In the above-described embodiments, the fixing protrusions 152 or 324 are formed on the case 200 or the protective circuit module 300′. However, the embodiments of the present invention are not limited thereto. For example, fixing protrusions may be formed on the case 200 and the protective circuit module 300′.

It should be understood that the exemplary embodiments described herein should be considered in a descriptive sense only and not for purposes of limitation. Descriptions of features or aspects within each embodiment should typically be considered as available for other similar features or aspects in other embodiments.

While one embodiment of the present invention has been described with reference to the figures, it will be understood by those of ordinary skill in the art that various changes in form and details may be made therein without departing from the spirit and scope of the present invention as defined by the following claims.

What is claimed is:

1. A battery pack comprising:
a battery cell comprising a terrace part and one or more coupling holes formed in the terrace part; and
a case accommodating the battery cell and comprising a fixing protrusion configured to be coupled to the coupling hole,
wherein the battery cell further comprises:
an electrode assembly in which a positive electrode plate, a separator, and a negative electrode plate are sequentially stacked;
a pouch in which the electrode assembly is sealed; and
a lead tab connected to the electrode assembly and partially exposed to an outside of the pouch.

2. The battery pack of claim 1, wherein the coupling hole is formed in the terrace part through the pouch.

3. The battery pack of claim 1, wherein the coupling hole is spaced apart from the lead tab.

4. The battery pack of claim 1, wherein the lead tab comprises first and second lead tabs having different polarities, and
the coupling holes are formed in the terrace part with the first and second lead tabs being disposed therebetween.

5. The battery pack of claim 1, wherein the terrace part comprises an insulation member surrounding the lead tab.

6. The battery pack of claim 1, wherein the case comprises:
a first support portion accommodating the battery cell and comprising the fixing protrusion supporting the battery cell; and
a second support portion accommodating and supporting a protective circuit module.

7. The battery pack of claim 6, wherein the fixing protrusion protrudes from the first support portion and corresponds to the coupling hole.

8. The battery pack of claim 6, wherein the case comprises a plurality of first support portions at left and right sides of the second support portion to accommodate a plurality of battery cells.

9. The battery pack of claim 6, wherein the lead tab of the battery cell faces the second support portion, and the battery cell is connected to the protective circuit module.

10. The battery pack of claim 6, wherein the first support portion is in a thermal contact with the pouch for dissipating heat.

11. The battery pack of claim 1, wherein the coupling hole is coupled with the fixing protrusion for insulating the battery cell.

12. A battery pack comprising:
a battery cell comprising a terrace part and at least one coupling hole formed in the terrace part; and
a case accommodating the battery cell and a protective circuit module, the protective circuit module comprising a fixing protrusion configured to be coupled to the coupling hole,
wherein the battery cell comprises:
an electrode assembly in which a positive electrode plate, a separator, and a negative electrode plate are sequentially stacked;
a pouch in which the electrode assembly is sealed; and
a lead tab connected to the electrode assembly and partially exposed to an outside of the pouch.

13. The battery pack of claim 12, wherein the case comprises:
a first support portion accommodating the battery cell; and
a second support portion accommodating the protective circuit module.

14. The battery pack of claim 13, wherein the case comprises a plurality of first support portions at left and right sides of the second support portion to accommodate a plurality of battery cells.

15. The battery pack of claim 12, wherein the coupling hole is formed in the terrace part through the pouch.

16. The battery pack of claim 12, wherein the coupling hole is spaced apart from the lead tab.

17. The battery pack of claim 12, wherein the battery cell further comprises an insulation member disposed at the terrace part to surround the lead tab.

18. The battery pack of claim 12, wherein the fixing protrusion corresponds to the coupling hole.

19. A battery pack comprising:
a battery cell comprising a terrace part;
a case accommodating the battery cell wherein a coupling hole is formed on one of the terrace part or the case and a fixing protrusion is formed on either the terrace part or the case that does not have the protrusion so that the fixing protrusion engages with the coupling hole to secure the case to the terrace part.

20. The battery pack of claim 19, wherein the battery cell further comprises:
an electrode assembly in which a positive electrode plate, a separator, and a negative electrode plate are sequentially stacked;
a pouch in which the electrode assembly is sealed; and
a lead tab connected to the electrode assembly and partially exposed to an outside of the pouch.

21. The battery pack of claim 19, wherein the coupling hole is formed on the terrace part and the fixing protrusion is formed on the case.

22. The battery pack of claim 19, wherein the protrusion part is formed on the terrace part and the coupling hole is formed on the case.
